(19) United States
(12) Patent Application Publication
(10) Pub. No.: US 2026/0239204 A1
(43) Pub. Date: Aug. 13, 2026

(54) METHOD AND APPARATUS FOR GROUP-BASED PAGING IN MOBILE COMMUNICATIONS

(71) Applicant: MEDIATEK INC., Hsinchu City (TW)

(72) Inventors: Yi-Ju LIAO, Hsinchu City (TW); Chien-Chun CHENG, Hsinchu City (TW); Wei-De WU, Hsinchu City (TW)

(73) Assignee: MEDIATEK INC., Hsinchu City (TW)

(21) Appl. No.: 19/472,874

(22) PCT Filed: Aug. 21, 2024
(86) PCT No.: PCT/CN2024/113584

§ 371 Date: Oct. 6, 2025

Related U.S. Application Data
(60) Provisional application No. 63/579,303, filed on Aug. 29, 2023.

(51) Int. Cl. H04W 52/02

(52) U.S. Cl. CPC H04W 52/0229; H04W 52/0219

(57) ABSTRACT

Various solutions for group-based paging with respect to user equipment and network apparatus in mobile communications are described. An apparatus may receive a paging indication from a network node. The apparatus may determine a starting time of a monitoring window based on a reception time of the paging indication in an event that the apparatus is indicated to wake up by the paging indication. The apparatus may perform a paging occasion (PO) monitoring within the monitoring window according to the starting time. The PO to be monitored may be aperiodic.

### CROSS REFERENCE TO RELATED PATENT APPLICATION(S)

The present disclosure is part of a non-provisional application claiming the priority benefit of U.S. Patent Application No. 63/579,303, filed 29 Aug. 2023, the content of which herein being incorporated by reference in its entirety.

### TECHNICAL FIELD

The present disclosure is generally related to mobile communications and, more particularly, to group-based paging with respect to user equipment and network apparatus in mobile communications.

### BACKGROUND

Unless otherwise indicated herein, approaches described in this section are not prior art to the claims listed below and are not admitted as prior art by inclusion in this section.

In fifth-generation (5G) new radio (NR) network, a procedure called paging is used to find out the location of a user equipment (UE) before the actual connection between the UE and the base station has been established. In most cases, the paging process happens while UE is in a radio resource control (RRC) idle mode. This means that UE has to monitor whether the network is sending any paging message to it and it has to spend some energy to run this “monitoring” process. In the RRC idle mode, a UE enters into and stays in a sleep mode defined in discontinuous reception (DRX) cycle. UE periodically wakes up and monitors physical downlink control channel (PDCCH) to check for the presence of a paging message. However, the current paging monitoring framework could cause significant power consumption at the UE. How to achieve energy efficiency optimization becomes an important issue in the newly developed wireless communication system. Therefore, there is a need to provide proper schemes for power consumption enhancement in paging procedure.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to group-based paging with respect to UE and network apparatus in mobile communications.

In one aspect, a method may involve an apparatus receiving a paging indication from a network node. The method may also involve the apparatus determining a starting time of a monitoring window based on a reception time of the paging indication in an event that the apparatus is indicated to wake up by the paging indication. The method may further involve the apparatus performing a paging occasion (PO) monitoring within the monitoring window according to the starting time.

In one aspect, an apparatus may comprise a transceiver which, during operation, wirelessly communicates with a network node. The apparatus may also comprise a processor communicatively coupled to the transceiver. The processor, during operation, may perform operations comprising receiving, via the transceiver, a paging indication from the network node. The processor may also perform operations comprising determining a starting time of a monitoring window based on a reception time of the paging indication in an event that the apparatus is indicated to wake up by the paging indication. The processor may further perform operations comprising performing a PO monitoring within the monitoring window according to the starting time.

In another aspect, a method may involve a network node transmitting a paging indication to a UE. The method may also involve the network node transmitting a physical downlink control channel (PDCCH) to the UE within a PO monitoring window in an event that a wake-up indication for the UE is carried in the paging indication. A starting time of the PO monitoring window may be associated with a paging indication reception time.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IoT), Narrow Band Internet of Things (NB-IoT), Industrial Internet of Things (IIoT), beyond 5G (B 5 G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of group-based paging in accordance with implementations of the present disclosure.

FIG. 2 is a diagram depicting another example scenario of group-based paging in accordance with implementations of the present disclosure.

FIG. 3 is a diagram depicting an example scenario of sub-group mapping in accordance with implementations of the present disclosure.

FIG. 4 is a diagram depicting yet another example scenario of group-based paging in accordance with implementations of the present disclosure.

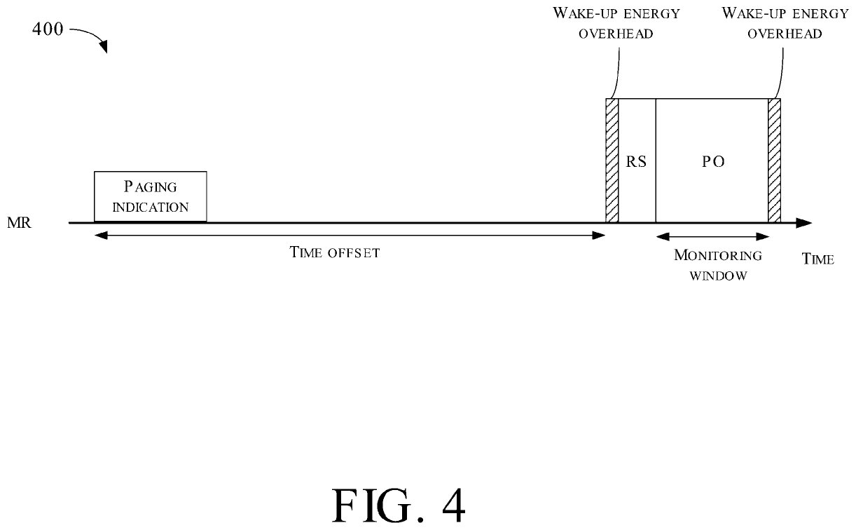

FIG. 5 is a block diagram of an example communication system in accordance with an implementation of the present disclosure.

FIG. 6 is a flowchart of an example process in accordance with an implementation of the present disclosure.

FIG. 7 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to group-based paging in mobile communications, so as to achieve better user equipment (UE) power consumption and paging latency trade-off. According to the present disclosure, a number of possible solutions may be implemented separately or jointly. That is, although these possible solutions may be described below separately, two or more of these possible solutions may be implemented in one combination or another.

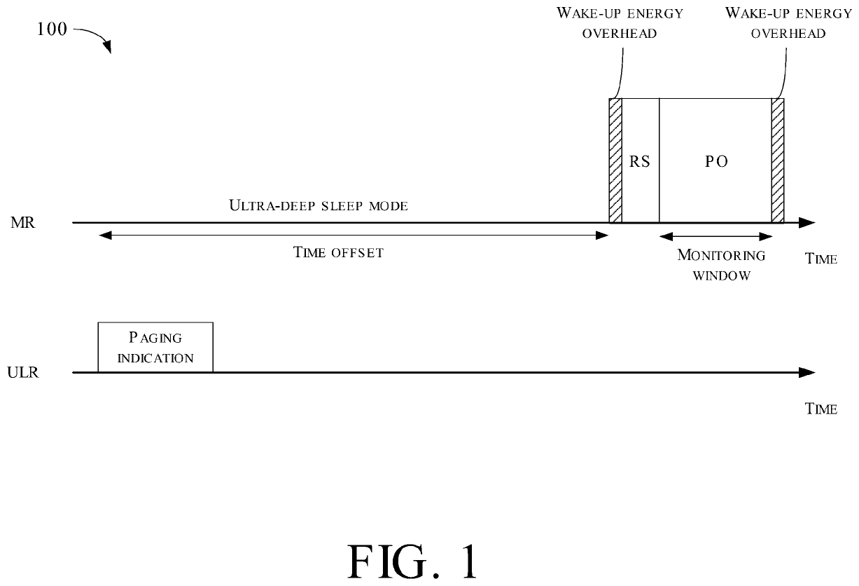

FIG. 1 illustrates an example scenario 100 of group-based paging in which various solutions and schemes in accordance with the present disclosure may be implemented. In scenario 100, the UE uses its ultra-low power radio/receiver (ULR) for paging indication monitoring to check whether it is indicated to wake up for paging occasion (PO) reception. The UE determines a starting time of a monitoring window based on the reception time of the paging indication in an event that the UE is indicated to wake up for PO reception by the paging indication. After that, the UE uses it main radio/receiver (MR) to perform a PO monitoring within the monitoring window according to the starting time. In scenario 100, the paging indication may carry one or a combination of the wake-up indication and the common message. The wake-up indication is associated with a UE or a UE group, and the common message may be the notification of the system information update or the notification of the emergency message such as the earthquake and tsunami warning system (ETWS) message and commercial mobile alert system (CMAS) message.

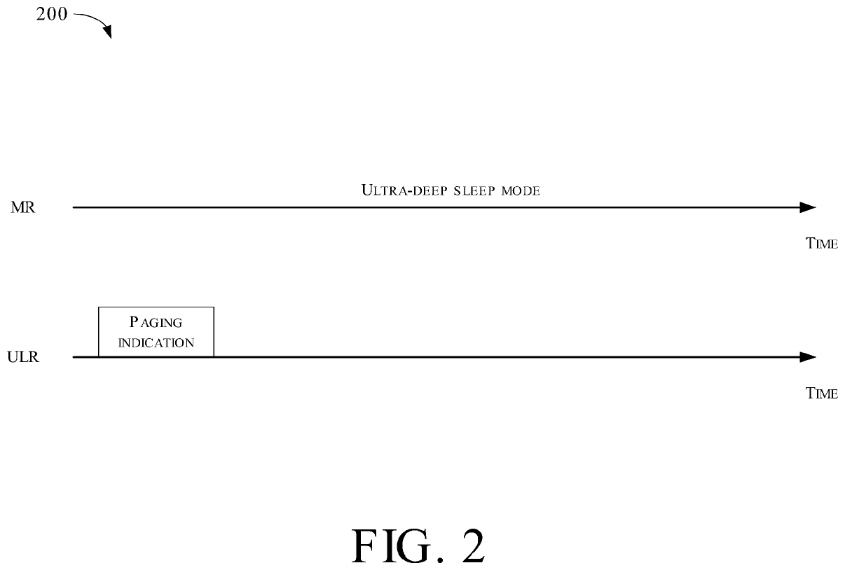

To be specific, when receiving the paging indication, the UE first determines whether the paging indication carries a wake-up indication. In an event that the paging indication carries a wake-up indication associated with the UE, the UE turns on the MR and starts to receive signal/channel via MR within the monitoring window. The starting time of the monitoring window is associated with reception time of the monitored paging indication. The PO monitoring may be associated with the reception time of the monitored paging indication. The PO monitoring may be aperiodic. For example, the monitoring window will be started after a time offset after the paging indication is received. The time offset and the monitoring window length may be determined based on one or more configurations from the network. In scenario 100, the MR of the UE remains in the deep sleep mode (e.g., ultra-deep sleep mode) until it has been turned on for PO monitoring. On the other hand, in an event that the paging indication does not carry any wake-up indication (e.g., only carries the common message), the MR remains in the ultra-deep sleep mode as shown in scenario 200 of FIG. 2.

In one embodiment, the UE may expect to receive an aperiodic reference signal (RS) only if the UE is indicated to wake up for PO reception by the paging indication, and the UE may perform a synchronization process (e.g., the time and frequency synchronization process) based on the aperiodic RS received before performing the PO monitoring.

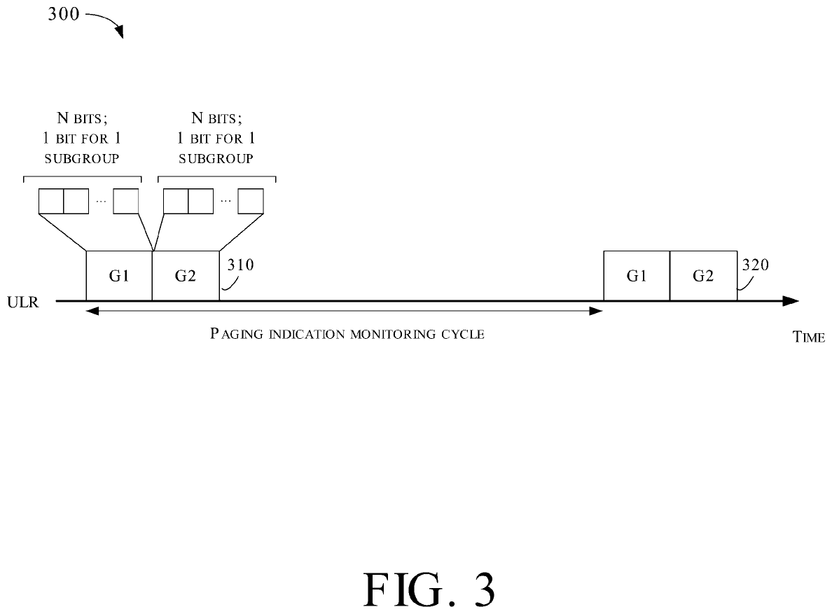

To further reduce the UE complexity and power consumption for paging indication monitoring, the paging indication may be a sequence-based indication, so that it can be processed by the baseband signal processing (e.g., sequence matching) rather than the decoding process. The sequence may be m-sequence, gold-sequence, ZC sequence or low-density power boosting (LDPB) sequence, however the present disclosure is not limited thereto. In the present disclosure, the UEs monitoring the same PO are further divided into subgroups, so as to reduce the false alarm rates. As shown in FIG. 3, each of the paging indications 310 and 320 corresponds to two UE groups G1 and G2, and each of G1 and G2 has N symbols to carry N bits, in which 1 bit is for 1 subgroup. Thus, in scenario 300, the total number of subgroups is 2×N. The UE is indicated to wake up in an event that the wake-up indication of the paging indication is associated with the subgroup of the UE.

For monitoring the paging indication, one or a combination of the paging indication periodicity, the frequency resource (e.g., the starting resource block and the resource block number), the sequence repetition number, the subgroup number, the subgroup bit to be read, the sequence root for signal generation, and the cyclic shift for signal generation are configured via higher layer signaling such as the master information block (MIB), System Information Blocks (SIBx) or radio resource control (RRC) release message. The UE may receive at least one of the foregoing configurations for paging indication monitoring. If the paging indication periodicity is not configured, the UE monitors the paging indication with a default periodicity. If the sequence repetition number is not configured, the UE receives the paging indication with a default repetition number (e.g., 1 or a predetermined number larger than 1); Otherwise, the signal is transmitted with replica according to the sequence repetition number. If the subgroup number is not configured, the UE assumes a default subgroup number for paging indication.

In one embodiment, the UE determines a monitoring occasion of the paging indication based on one or a combination of the user equipment group identity (UEID), the paging indication periodicity, and the monitoring occasion number within a time duration such as in a slot or in a frame, and then performs a paging indication monitoring on the monitoring occasion. For example, the monitoring occasion slot may be determined by the following relation:

### UEID Mod Paging Indication Periodicity in a Slot

In one embodiment, in an event that the paging indication carries the wake-up indication, the UE perform a sub-group mapping between the wake-up indication and the subgroup number of the UE, and determines that the UE is indicated to wake up by the paging indication in an event that a specific subgroup number indicated by the wake-up indication corresponds to the subgroup number of the apparatus. In one embodiment, the sub-group mapping may be explicitly indicated by the network. For example, assuming that the UE is indicated to be in subgroup 2 via the RRC release message, and the total number of subgroups is 8. The UE wakes up if receiving bit ‘010’ (total 3 bits for 8 subgroups) or if the second bit of the paging indication is ‘1’ (total 8 bits for 8 subgroups). In another embodiment, the sub-group mapping is derived based on the UEID and the total number of subgroups. For example, in an event that the UEID mod the total number of subgroups is equal to 2, the UE wakes up if receiving bit ‘010’ (total 3 bits for 8 subgroups) or if the second bit of paging indication is ‘1’ (total 8 bits for 8 subgroups). In one embodiment, to save the bit number for wake-up indication, a specific bit pattern (e.g., all ‘1’ or all ‘0’) may be used for indicating all UEs to wake up for PO monitoring.

In the foregoing embodiments, the UE uses its ULR to monitor the paging indication and uses its MR to monitor the PO. However, the present disclosure is not limited thereto. As specified in scenario 400, the UE may use its MR to monitor the paging indication as well as the PO. The sequence-based paging indication is used so that the UE may process the paging indication by a simple baseband signal processing. It should be noted that the schemes proposed in the present disclosure are note restricted to the architecture of dual radio layer (e.g., MR and ULR). In some implementations, it is also applicable to single radio layer or single transmitter (TX)/receiver (RX) only.

It should be noted that in the present disclosure, the PO is an aperiodic PO rather than a periodic PO. To be specific, the PO does not occur periodically, one or a combination of the starting time and the length of the monitoring window are configured via higher layer signaling (e.g., MIB, SIBx or RRC release message), so that the UE may performs the PO monitoring within the monitoring window according to the starting time.

### Illustrative Implementations

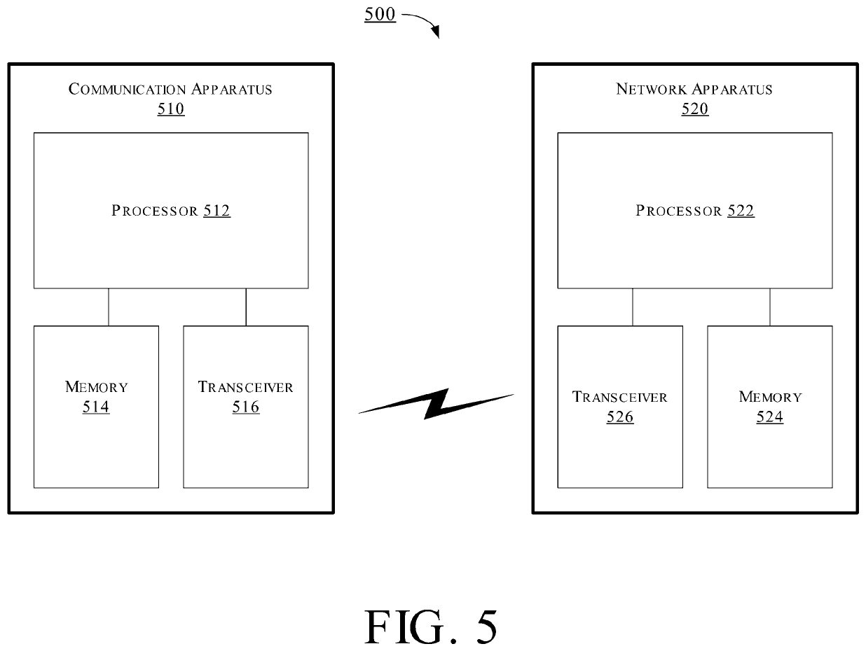

FIG. 5 illustrates an example communication system 500 having at least an example communication apparatus 510 and an example network apparatus 520 in accordance with an implementation of the present disclosure. Each of the communication apparatus 510 and network apparatus 520 may perform various functions to implement schemes, techniques, processes and methods described herein pertaining to group-based paging in mobile communications, including scenarios/schemes described above as well as process 600 and process 700 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of a network apparatus, which may be a network node such as a satellite, a base station, a small cell, a router or a gateway. For instance, network apparatus 520 may be implemented in an eNodeB in an LTE network, in a gNB in a 5G/NR, IoT, NB-IoT or IIoT network or in a satellite or base station in a 6G network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of the processor 512 and processor 522 may be implemented in the form of one or more single-core processors, one or more multi-core processors, or one or more CISC processors. That is, even though a singular term “a processor” is used herein to refer to processor 512 and processor 522, each of the processor 512 and processor 522 may include multiple processors in some implementations and a single processor in other implementations in accordance with the present disclosure. In another aspect, each of the processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 512 and processor 522 is a special-purpose machine specifically designed, arranged and configured to perform at least a part of the specific tasks including group-based paging in a device (e.g., as represented by communication apparatus 510) and a network (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, transceiver 516 may comprises a main receiver and a low power receiver. In some implementations, transceiver 516 may comprises only a main receiver. In some implementations, communication apparatus 510 may further include a memory 514 coupled to processor 512 and capable of being accessed by processor 512 and storing data therein.

In some implementations, network apparatus 520 may further include a memory 524 coupled to processor 522 and capable of being accessed by processor 522 and storing data therein. Accordingly, communication apparatus 510 and network apparatus 520 may wirelessly communicate with each other via transceiver 516 and transceiver 526, respectively.

For illustrative purposes and without limitation, descriptions of capabilities of each of communication apparatus 510 and network apparatus 520 are provided below with process 600 and process 700. In which, the communication apparatus 510 is implemented in or as a communication apparatus or a UE and network apparatus 520 is implemented in or as a network node of a communication network.

### Illustrative Processes

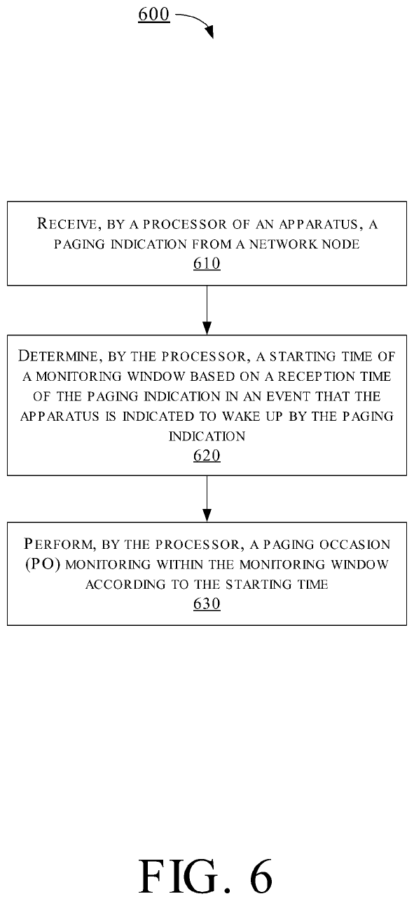

FIG. 6 illustrates an example process 600 in accordance with an implementation of the present disclosure. Process 600 may be an example implementation of above scenarios/schemes, whether partially or completely, with respect to group-based paging in mobile communications. Process 600 may represent an aspect of implementation of features of communication apparatus 510. Process 600 may include one or more operations, actions, or functions as illustrated by one or more of blocks 610, 620, and 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 510 or any suitable UE or machine type devices. Solely for illustrative purposes and without limitation, process 600 is described below in the context of communication apparatus 510 as a UE. Process 600 may begin at block 610.

At 610, process 600 may involve processor 512 of communication apparatus 510 receiving a paging indication from a network node (e.g., the network apparatus 520). Process 600 may proceed from 610 to 620.

At 620, process 600 may involve processor 512 determining a starting time of a monitoring window based on a reception time of the paging indication in an event that the communication apparatus 510 is indicated to wake up by the paging indication. Process 600 may proceed from 620 to 630.

At 630, process 600 may involve processor 512 performing a paging occasion (PO) monitoring within the monitoring window according to the starting time.

In some implementations, process 600 may involve processor 512 determining whether the paging indication carries a wake-up indication. Also, process 600 may involve processor 512 performing a sub-group mapping between the wake-up indication and a subgroup number of the communication apparatus 510 in an event that the paging indication carries the wake-up indication. Furthermore, process 600 may involve processor 512 determining that the communication apparatus 510 is indicated to wake up by the paging indication in an event that a specific subgroup number indicated by the wake-up indication corresponds to the subgroup number of the communication apparatus 510.

In some implementations, the subgroup number of the communication apparatus 510 comprises a configured subgroup number or a default subgroup number.

In some implementations, process 600 may involve processor 512 receiving one or more configurations for a paging indication monitoring. Also, process 600 may involve processor 512 determining a monitoring occasion of the paging indication based on one or a combination of a user equipment group identity (UEID), a paging indication periodicity, and a monitoring occasion number within a time duration. Further, process 600 may involve processor 512 performing the paging indication monitoring on the monitoring occasion.

In some implementations, the configurations for the paging indication monitoring relate to one or a combination of the paging indication periodicity, a frequency resource, a sequence repetition number, a subgroup number, a subgroup bit to be read, a sequence root for signal generation, and a cyclic shift for signal generation.

In some implementations, a default periodicity may be used by the processor 512 in an event that the one or more configurations are not related to the paging indication periodicity. Also, a default repetition number may be used by the processor 512 in an event that the one or more configurations are not related to the sequence repetition number. Further, a default subgroup number may be used by the processor 512 in an event that the one or more configurations are not related to the subgroup number.

In some implementations, process 600 may involve processor 512 receiving one or more configurations of a time offset for determining the starting time, and a monitoring window length.

In some implementations, process 600 may involve processor 512 receiving an aperiodic RS in an event that the apparatus is indicated to wake up by the paging indication and performing a synchronization process based on an aperiodic reference signal (RS) received before performing the PO monitoring.

In some implementations, the paging indication is monitored by a low power receiver of the communication apparatus 510, and the PO is monitored by a main receiver of the communication apparatus 510.

In some implementations, the paging indication as well as the PO are monitored by the main receiver of the communication apparatus 510,

In some implementations, the paging indication comprises a sequence-based indication.

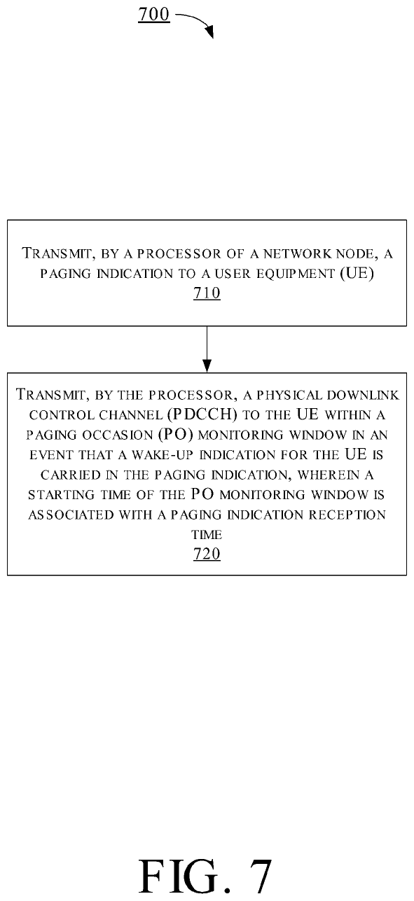

FIG. 7 illustrates an example process 700 in accordance with an implementation of the present disclosure. Process 700 may be an example implementation of above scenarios/schemes, whether partially or completely, with respect to group-based paging in mobile communications. Process 700 may represent an aspect of implementation of features of network apparatus 520. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by network apparatus 520 or any base stations or network nodes. Solely for illustrative purposes and without limitation, process 700 is described below in the context of network apparatus 520. Process 700 may begin at block 710.

At 710, process 700 may involve processor 522 of network apparatus 520 transmitting a paging indication to a user equipment (e.g., the communication apparatus 510). Process 700 may proceed from 710 to 720.

At 720, process 700 may involve processor 522 transmitting a physical downlink control channel (PDCCH) to the UE within a paging occasion (PO) monitoring window in an event that a wake-up indication for the UE is carried in the paging indication, wherein a starting time of the PO monitoring window is associated with a paging indication reception time.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a paging indication from a network node;
determining, by the processor, a starting time of a monitoring window based on a reception time of the paging indication in an event that the apparatus is indicated to wake up by the paging indication; and
performing, by the processor, a paging occasion (PO) monitoring within the monitoring window according to the starting time.

2. The method of claim 1, further comprising:
determining, by the processor, whether the paging indication carries a wake-up indication;
performing, by the processor, a sub-group mapping between the wake-up indication and a subgroup number of the apparatus in an event that the paging indication carries the wake-up indication; and
determining, by the processor, that the apparatus is indicated to wake up by the paging indication in an event that a specific subgroup number indicated by the wake-up indication corresponds to the subgroup number of the apparatus.

3. The method of claim 2, wherein the subgroup number of the apparatus comprises a configured subgroup number or a default subgroup number.

4. The method of claim 1, further comprising:
receiving, by the processor, one or more configurations for a paging indication monitoring;
determining, by the processor, a monitoring occasion of the paging indication based on one or a combination of a user equipment group identity (UEID), a paging indication periodicity, and a monitoring occasion number within a time duration; and
performing, by the processor, the paging indication monitoring on the monitoring occasion.

5. The method of claim 4, wherein the one or more configurations for the paging indication monitoring relate to one or a combination of the paging indication periodicity, a frequency resource, a sequence repetition number, a subgroup number, a subgroup bit to be read, a sequence root for signal generation, and a cyclic shift for signal generation.

6. The method of claim 5, wherein:
a default periodicity is used by the processor in an event that the one or more configurations are not related to the paging indication periodicity;
a default repetition number is used by the processor in an event that the one or more configurations are not related to the sequence repetition number; and
a default subgroup number is used by the processor in an event that the one or more configurations are not related to the subgroup number.

7. The method of claim 1, further comprising:
receiving, by the processor, one or more configurations of a time offset for determining the starting time, and a monitoring window length.

8. The method of claim 1, further comprising:
receiving, by the processor, an aperiodic reference signal (RS) in an event that the apparatus is indicated to wake up by the paging indication; and
performing, by the processor, a synchronization process based on the aperiodic RS received before performing the PO monitoring.

9. The method of claim 1, wherein the paging indication is monitored by a low power receiver or a main receiver of the apparatus, and the PO is monitored by the main receiver of the apparatus.

10. The method of claim 1, wherein the paging indication comprises a sequence-based indication.

11. An apparatus, comprising:
a transceiver which, during operation, communicates wirelessly; and
a processor communicatively coupled to the transceiver such that, during operation, the processor performs operations comprising:
receiving, via the transceiver, a paging indication from a network node;
determining a starting time of a monitoring window based on a reception time of the paging indication in an event that the apparatus is indicated to wake up by the paging indication; and
performing a paging occasion (PO) monitoring within the monitoring window according to the starting time.

12. The apparatus of claim 11, wherein, during operation, the processor further performs operations comprising:
determining whether the paging indication carries a wake-up indication;
performing a sub-group mapping between the wake-up indication and a subgroup number of the apparatus in an event that the paging indication carries the wake-up indication; and
determining that the apparatus is indicated to wake up by the paging indication in an event that a specific subgroup number indicated by the wake-up indication corresponds to the subgroup number of the apparatus.

13. The apparatus of claim 12, wherein the subgroup number of the apparatus comprises a configured subgroup number or a default subgroup number.

14. The apparatus of claim 11, wherein, during operation, the processor further performs operations comprising:
receiving, via the transceiver, one or more configurations for a paging indication monitoring;
determining a monitoring occasion of the paging indication based on one or a combination of a user equipment group identity (UEID), a paging indication periodicity, and a monitoring occasion number within a time duration; and
performing the paging indication monitoring on the monitoring occasion.

15. The apparatus of claim 14, wherein the one or more configurations for the paging indication monitoring relate to one or a combination of the paging indication periodicity, a frequency resource, a sequence repetition number, a subgroup number, a subgroup bit to be read, a sequence root for signal generation, and a cyclic shift for signal generation.

16. The apparatus of claim 15, wherein:
a default periodicity is used by the processor in an event that the one or more configurations are not related to the paging indication periodicity;
a default repetition number is used by the processor in an event that the one or more configurations are not related to the sequence repetition number; and
a default subgroup number is used by the processor in an event that the one or more configurations are not related to the subgroup number.

17. The apparatus of claim 11, wherein, during operation, the processor further performs operations comprising:
receiving, via the transceiver, one or more configurations of a time offset for determining the starting time, and a monitoring window length.

18. The apparatus of claim 11, wherein, during operation, the processor further performs operations comprising:
receiving an aperiodic reference signal (RS) in an event that the apparatus is indicated to wake up by the paging indication; and
performing a synchronization process based on the aperiodic RS before performing the PO monitoring.

19. The apparatus of claim 11, wherein the transceiver comprises:
a low power receiver which, during operation, monitors the paging indication; and
a main receiver which, during operation, monitor the PO.

20. The apparatus of claim 11, wherein the transceiver comprises:
a main receiver which, during operation, monitors the paging indication and the PO.

21. The apparatus of claim 11, wherein the paging indication comprises a sequence-based indication.

22. A method, comprising:
transmitting, by a processor of a network node, a paging indication to a user equipment (UE); and
transmitting, by the processor, a physical downlink control channel (PDCCH) to the UE within a paging occasion (PO) monitoring window in an event that a wake-up indication for the UE is carried in the paging indication, wherein a starting time of the PO monitoring window is associated with a paging indication reception time.
